(19) United States
(12) Patent Application Publication
(10) Pub. No.: US 2008/0120852 A1
(43) Pub. Date: May 29, 2008

(54) ROOF PITCH GAUGE

(76) Inventor: Jeffrey RAMSEY, Bellefontaine, OH (US)

Correspondence Address: STANDLEY LAW GROUP LLP, 495 METRO PLACE SOUTH, SUITE 210, DUBLIN, OH, 43017, US

(21) Appl. No.: 11/564,315

(22) Filed: Nov. 29, 2006

(51) Int. Cl. G01C 15/10

(52) U.S. Cl. 33/285

(57) ABSTRACT

A roof pitch measuring device (10) is made of relatively lightweight, transparent plastic. Roof pitches can be determined from a point remote from the roof in a simple, easy to learn manner. The measuring device has a base with spirit level (22), an adjustable pivot arm (30) and a scale (52). The spirit level should be visible from each side of the base. The pivot arm is pivotably attached to the base at a pivot point (40). The roof pitch gauge is preferably utilized by a user standing at least 36 feet from the roof whose pitch is being measured, lining up the pivot point of the pivot arm with the peak of the roof, leveling the device, moving the pivot arm to match the angle of the roof and then reading the roof pitch from the scale that is printed upon the device.

### CROSS-REFERENCE TO RELATED APPLICATIONS

The present application makes no claim of priority to any earlier filings.

### TECHNICAL FIELD

The disclosed embodiments of the present invention provide a simple and affordable gauge for measuring the pitch of a roof from a location remote from the roof.

### BACKGROUND OF THE ART

Workers in the construction and residential housing repair industries are commonly required to determine the pitch, also referred to as the rake, of a roof surface. By definition, the “pitch” of a roof is the “rise”, or change in the vertical direction, for every foot of “run,” or change in the horizontal direction, of the roof. For example, an “8 pitch” roof has 8 inches or “rise” per foot of horizontal “run.” In some other countries, the pitch is defined as the angle between the roof edge and the horizontal, so the same 8 pitch roof would have an angle of almost 37°.

Since the run of a roof may be measured from the ground, as may be the width, determination of the roof pitch from the ground is also a desired objective, as this allows the area of the roof surface to be determined. In most instances, accuracy to within 0.5 inches is sufficient.

Many of the prior art devices for measuring roof pitch require direct measurement of the angle of incline of the roof edge, which may be inconvenient and which poses unneeded risk of falling, etc. to the worker.

It is, therefore, an unmet objective of the prior art to provide a device and method for determining roof pitch from a point remote to the roof. A particularly preferred device provides a direct reading of the pitch rather than the angle of incline, so that no mathematical conversion is required.

### SUMMARY OF THE INVENTION

This and other advantages are achieved by the device and method of the appended claims.

In particular, an instrument for gauging a pitch of a roof or the like from a position off of the roof comprises a transparent base, a spirit level, a pivot arm and a calibrated scale. The spirit level is affixed to the base and the pivot arm is fixed to the base at a pivot point near a first end thereof. The calibrated scale is disposed on the base near a second end of the pivot arm.

The method for gauging a pitch of a roof or the like from a position off of the roof, comprises the steps of: providing an instrument as described immediately above; aligning the instrument by centering the bubble of the spirit level while the pivot point of the pivot arm is pointed at a peak of the roof to be measured, with the measuring line of the pivot arm extending away from the pivot point in the same direction as the edge of the roof by viewing the roof through the transparent base; moving the pivot arm to align the measuring line with the roof edge; and reading the roof pitch along the calibrated scale on the base.

### BRIEF DESCRIPTION OF THE DRAWINGS

A better understanding of the present exemplary embodiments will be had when reference is made to the accompanying drawings, wherein identical parts are identified with identical reference numerals, and wherein:

FIG. 1 is a perspective view of an embodiment of the roof pitch measuring gauge; and

FIG. 2 is a front view of the FIG. 1 embodiment in use, measuring the pitch of a roof.

### DETAILED DESCRIPTION OF AN EXEMPLARY EMBODIMENT

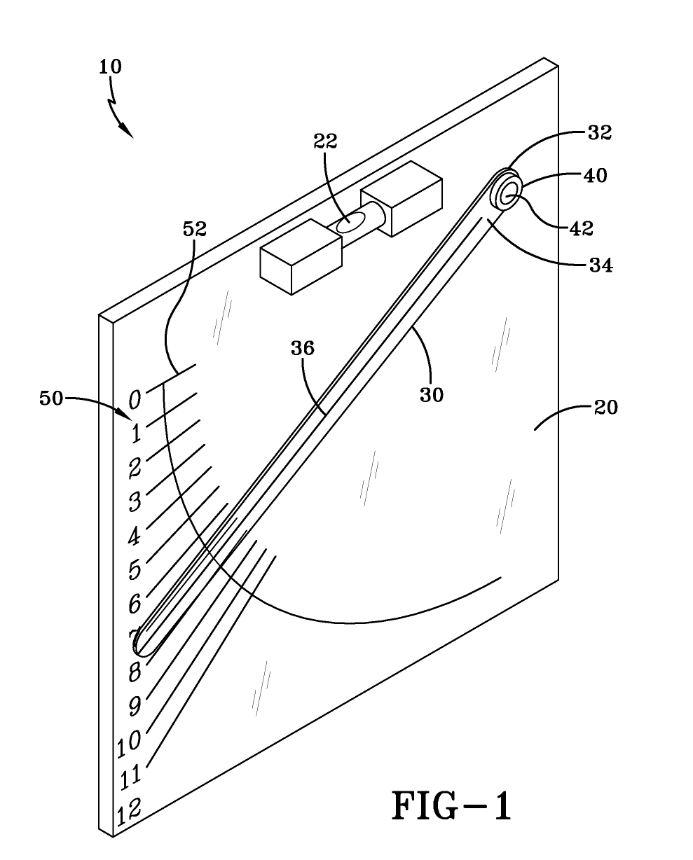

Directing attention to FIG. 1, a front view of an exemplary embodiment 10 of the roof pitch instrument is shown. This instrument 10 has a transparent base 20, which is shown in a preferred manner, that is, as a rectangular plate. The plate may be a glass or polymeric material, but an especially preferred material is relatively resistant to surface scratching and the plate should have sufficient thickness to resist flexing, as flexing of the instrument during use could deleteriously affect the accuracy of the measurement obtained.

As will be explained below with regard to use of the instrument 10, the accuracy of the measurement will be strongly dependent upon proper alignment of the instrument 10 during use. For that reason, the instrument 10 is provided with a spirit level 22 affixed to the base 20. Spirit levels are well-known in the art. A spirit level has a gas bubble, movably trapped within a generally liquid-filled longitudinal tube having a pair of inscribed calibration lines. When the bubble is bracketed between the inscribed lines, the longitudinal axis of the spirit level is horizontally aligned, that is, it is parallel to the ground, as the “run” of a roof would be. While spirit levels are available with a variety of structural features that make them extremely accurate if required, this level of sophistication is generally not required in the present application.

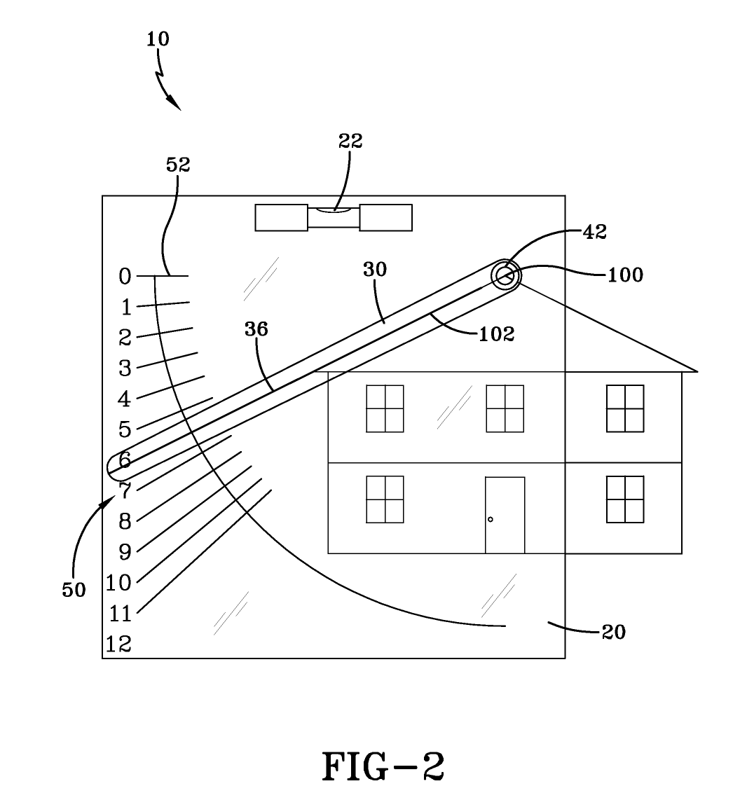

FIG. 1 also shows a pivot arm 30 as a part of the instrument 10. The pivot arm 30 is fixed to the base 20 at a pivot point 32 near a first end 34 of the pivot arm. In the illustrated embodiment, the pivot point 32 is located near a corner of the rectangular base 20, particularly, the upper right corner. Also in the embodiment shown, the pivot arm 30 is fabricated from a transparent material and has a longitudinally extending measurement line 36 disposed thereon. The transparent nature of the pivot arm 30, in combination with the transparent base 20, allows a user to easily sight a roof peak 100 and edge 102 through the device 10, as is best seen in FIG. 2. The measurement line 36 is preferred to be much narrower than the pivot arm 30, so that the pivot arm can be accurately aligned along the view of the roof edge taken through the device 10. The pivot arm 30 is pivotably fixed to the base 20 with a pivot pin 40. In a preferred embodiment, this pin 40 has a central longitudinal aperture 42. As will be described in more detail below, this aperture 42 allows a precise positioning of the roof peak 100 being gauged in the view obtained through the device 10 by a user.

Other notable aspects of the pivot arm 30 include the fact that it should be short enough that it does not extend over any of the edges of the device 10 as it moves through the approximately 90 degrees of its normal range of pivoting. Some models of the device 10 will have a stop element provided on the base 20, the pivot arm 30, or both, to delimit the pivoting of the pivot arm within that range. While the pivot arm 30 should be able to pivot about the pivot point, it is a very useful to have the pivot pin 40 hold the pivot arm in place through friction when the arm is not being actively moved by the user. Particularly, the pivot pin 40 should hold the pivot arm 30 against the pull of gravity, so that a user can take a sighting through the device, align the pivot arm and have the pivot arm hold that position while the position is logged by the user.

A further feature of the invention shown in FIG. 1 is a calibrated scale 50 that is disposed on the base 20. The illustrated embodiment shows a series of numerical indicia, particularly, the integers from 0 through 12, each numeral associated with a line 52 extending from near the numeral towards the pivot point 40. These lines 52 should each be very narrow, so as to not obstruct the view through the device 10, and each should extend far enough towards the pivot point 40 so that the pivot arm 30 and especially the measurement line 36 will overlap the lines when a roof pitch measurement is being made.

While the illustrated embodiment shows each integer between 0 and 12, the calibration scale can go higher than 12, although it will not be common to see roofs of such a high pitch in the United States. Instead of showing each integer with a number, as shown, the device may be calibrated with fewer numbers, although the lines 52 shown should be provided for at least each inch of pitch between 0 and 12, and it would not be impractical to even show 0.5 inch increments of pitch.

Further on the issue of the calibration scale, it is notable that the line 52 associated with a roof pitch of 0 inches, that is, a flat roof, is parallel to the longitudinal axis of the spirit level 22.

With this description of the device 10 in hand, attention is directed to the use thereof. As shown, the device 10 is calibrated to read the pitch of a roof edge 102 that is inclined from the user's left upwardly towards the user's right. If the roof edge is inclined oppositely, that is, from the user's right downwardly towards the user's left, then the device is used by turning it and looking through the opposite planar surface, that is, in a manner where the pivot point is positioned in the upper left corner rather than the upper right corner. For this reason, it is very useful to use a spirit level 22 in which the bubble may be observed from either side of the base 20, as is illustrated in the Figures.

With device 10 as described in hand, the user positions himself at a point at least 36 feet away from the roof 100, preferably at ground level or at a level roughly that of the roof. Holding the device 10 in front of the user and centering the pivot point 40 with the view of the roof peak 100 to be measured and the roof edge 102 inclining away from the pivot point within the area of the calibration scale 50 on the device, the device is aligned by assuring that the bubble in the spirit level 22 is bracketed within its calibration lines. Continuing to view the roof 100, the user moves the pivot arm 30 to align the measuring line 36 along the sighted roof edge 102, so that the measuring line overlaps the calibration scale on the base in the manner shown in FIG. 2. By reading the calibration scale 52, the roof pitch is determined. For example, the roof edge 102 in FIG. 2 is at a pitch of 6.

To correctly and accurately measure and read the pitch of a roof 100 with the gauge 10, a user must stand approximately 36 feet from the roof being measured. While the gauge will work standing closer or farther, for each 9 feet you stand closer, ½ inch pitch must be added to the reading from the scale, to compensate for the angle at which the roof is being viewed.

Unless particularly excluded, any disclosed embodiment may include any of the optional or preferred features of the other embodiments. The exemplary embodiments herein disclosed are not intended to be exhaustive or to unnecessarily limit the scope of the invention. The exemplary embodiments were chosen and described in order to explain the principles utilized, so that others skilled in the art may practice the invention. Having shown and described exemplary embodiments, those skilled in the art will realize that many variations and modifications may be made to affect the described invention. Many of those variations and modifications will provide the same result and fall within the spirit of the appended claims.

What is claimed is:

1. An instrument for gauging a pitch of a roof or the like from a position off of the roof, comprising:
a transparent base;
a spirit level affixed to the base;
a pivot arm, fixed to the base at a pivot point near a first end thereof; and
a calibrated scale on the base.

2. The instrument of claim 1, wherein:
the spirit level is aligned on the base such that a longitudinal axis of the spirit level is parallel to a line between the pivot point and a calibration corresponding to a roof pitch of 0 inches.

3. The instrument of claim 2, wherein:
the base is a rectangular plate.

4. The instrument of claim 3, wherein:
the pivot point is located near a corner of the rectangular base.

5. The instrument of claim 4, wherein:
the spirit level is affixed to a surface of the plate between an edge the plate and the line between the pivot point and a calibration corresponding to a roof pitch of 0 inches

6. The instrument of claim 5, wherein:
the pivot arm is transparent, with a longitudinally extending measurement line.

7. The instrument of claim 6, wherein:
the pivot arm is fixed to the base with a pivot pin.

8. The instrument of claim 7, wherein:
the pivot pin has a central longitudinal aperture.

9. The instrument of claim 8, wherein:
the pivot arm and the measurement line thereof overlap the marks of the calibration scale when the pivot arm is positioned with the limits of the scale.

10. The instrument of claim 9, wherein:
the scale is calibrated for roof pitches from 0 inches to at least 12 inches, with markings for at least every two inches of the range.

11. The instrument of claim 1, wherein:
the base is a rectangular plate.

12. The instrument of claim 11, wherein:
the pivot point is located near a corner of the rectangular base.

13. The instrument of claim 1, wherein:
the pivot arm is transparent, with a longitudinally extending measurement line.

14. The instrument of claim 1, wherein:
the pivot arm is fixed to the base with a pivot pin.

15. The instrument of claim 14, wherein:
the pivot pin has a central longitudinal aperture.

16. The instrument of claim 1, wherein:
the pivot arm and the measurement line thereof overlap the marks of the calibration scale when the pivot arm is positioned with the limits of the scale.

17. The instrument of claim 1, wherein:
the scale is calibrated for roof pitches from 0 inches to at least 12 inches, with markings for at least every two inches of the range.

18. A method for gauging a pitch of a roof or the like from a position off of the roof, comprising the steps of:
providing an instrument according to claim 1;
aligning the instrument by centering the bubble of the spirit level while the pivot point of the pivot arm is pointed at a peak of the roof to be measured, with the measuring line of the pivot arm extending away from the pivot point in the same direction as the edge of the roof by viewing the roof through the transparent base;
moving the pivot arm to align the measuring line with the roof edge; and
reading the roof pitch along the calibrated scale on the base.
